(19) United States
(12) Patent Application Publication
(10) Pub. No.: US 2011/0060750 A1
(43) Pub. Date: Mar. 10, 2011

(54) MAX-VALUE-FIRST SEARCH FOR TARGET VALUE PROBLEMS

(75) Inventors: Lukas Daniel Kuhn, Palo Alto, CA (US); Johan deKleer, Los Altos, CA (US); Tim Schmidt, Palo Alto, CA (US); Rong Zhou, Cupertino, CA (US)

(73) Assignee: PALO ALTO RESEARCH CENTER INCORPORATED, Palo Alto, CA (US)

(21) Appl. No.: 12/636,089

(22) Filed: Dec. 11, 2009

Related U.S. Application Data
(60) Provisional application No. 61/240,428, filed on Sep. 8, 2009.

(51) Int. Cl. G06F 17/30

(52) U.S. Cl. 707/758; 707/E17.014; 707/798; 707/E17.011

(57) ABSTRACT

The present application relates to systems and methods for determining at least one target path from a start vertex to a goal vertex within a directed acyclic graph. The systems and methods use a target value search (MFTVS) of a directed acyclic graph. The MFTVS includes beginning with a start vertex as a current prefix and progressing through selected prefixes. The MFTVS further includes determining a selected prefix from successor prefixes of the current prefix according to a selection rule. The selection rule is one of selecting the successor prefix having a highest path value and selecting the successor prefix having a lowest path value. The MFTVS further includes setting the current prefix to the selected prefix until a frontier of a blind spot is encountered. The frontier of the blind spot is defined by an evaluation function.

### CROSS REFERENCE TO RELATED PATENTS AND APPLICATIONS

This application claims priority to and the benefit of U.S. Provisional Application No. 61/240,428, entitled “MAX-VALUE-FIRST SEARCH FOR TARGET VALUE PROBLEMS”, filed Sep. 8, 2009, incorporated herein by reference in its entirety.

### INCORPORATION BY REFERENCE

The disclosures of U.S. patent application Ser. No. 12/497,326 for “Depth-First Search for Target Value Problems,” by Schmidt et al., filed Jul. 2, 2009; U.S. patent application Ser. No. 12/409,235 for “Methods and Systems for Target Value Path Identification,” by Kuhn et al., filed Mar. 23, 2009; U.S. patent application Ser. No. 12/497,353 for “Multi-Interval Heuristics for Accelerating Target-Value Search,” by Schmidt et al., filed Jul. 2, 2009; U.S. patent application Ser. No. 12/170,542 for “Methods and Systems For Pervasive Diagnostics,” by de Kleer et al., filed Jul. 10, 2008; and U.S. patent application Ser. No. 12/170,577 for “Methods and Systems for Constructing Production Plans,” by Kuhn et al., filed Jul. 10, 2008, are each hereby incorporated herein by reference in their entireties.

### BACKGROUND

The present exemplary embodiments relate to systems and methods for target-value searching that can be used in a variety of settings, such as online diagnosis for production planning systems and systems for providing consumers with targeted search results. However, it is to be appreciated that the present exemplary embodiments are also amenable to other like applications.

Automated production planning systems may require selection of plant resources to produce a given product while intelligently employing certain production resources to obtain diagnostic information indicating the probability of particular resources being faulty. In this situation, the diagnostic goals of the planner may not be facilitated by simply selecting the shortest or fastest set of resources to build the product, but instead by selecting a plan defining a sequence of resources that build the product while testing fault probabilities that are non-zero.

In another example, consumers may desire a planner to identify vacation plans to a certain destination (or multiple prospective destinations) that have a certain duration (or range of durations, such as 5-7 days with start and end dates in a specified month) and that have a given target cost or cost range. Mapping systems may be required in a further application that can receive starting and ending locations, as well as a target distance and/or time values for planning a drive for viewing autumn leaves where the consumer wants a trip plan that lasts for 3-5 hours during daylight through parks in the month of October.

In the past, search problems were solved using minimization algorithms to find the shortest path or paths between a starting state and a goal state. However, the goal in certain applications is not necessarily to find paths with minimum length or cost, but instead the desired path that has a non-zero or non-minimal cost or duration. Using shortest-path searching techniques in these situations involves identifying the shortest paths, and eliminating or exonerating those identified paths that do not fall within a target value range. The process would then be repeated until paths are identified that are within the desired range. This approach is impractical in most real-life applications, whereby a need exists for efficient target value path searching techniques and systems for use in identifying one or more paths having a value closest to a given target value.

The present application contemplates new and improved systems and/or methods which may be employed to mitigate the above-referenced problems and others.

### BRIEF DESCRIPTION

In accordance with one aspect of the present application, a computer implemented method for determining at least one target path from a start vertex to a goal vertex within a directed acyclic graph is illustrated. The directed acyclic graph includes a plurality of prefixes defining a search space. The prefixes individually include at least one range, a path value and a target value to go. Beginning with the start vertex as a current prefix and progressing through selected prefixes, the method includes determining a selected prefix from successor prefixes of the current prefix according to a selection rule. The selection rule of the method is either selecting the successor prefix having a highest path value or selecting the successor prefix having a lowest path value. The method further includes setting the current prefix to the selected prefix until a frontier of a blind spot is encountered, where the blind spot frontier is defined by an evaluation function. The method further includes completing at least one of the prefixes to determine the at least one target path.

In accordance with another aspect of the present application, a model based control system for controlling a production system is illustrated. The system includes a directed acyclic graph extending between a start vertex and a goal vertex. The directed acyclic graph includes a plurality of prefixes defining a search space and individually including at least one range, a path value and a target value to go. The system also includes a planner operative to provide the production system with at least one plan with a failure probability most closely approximating a target value. The planner generates the plan using a target value search of the directed acyclic graph that begins with the start vertex as a current prefix and progresses through selected prefixes, and includes determining a selected prefix from successor prefixes of the current prefix according to a selection rule. The selection rule is one of selecting the successor prefix having a highest path value and selecting the successor prefix having a lowest path value. The target value search further includes setting the current prefix to the selected prefix until a frontier of a blind spot is encountered, where the frontier is defined by an evaluation function. The target value search further includes completing at least one of the plurality of prefixes to determine the at least one plan. The model based control system further includes a system model operative to model the behavior of the plant and a diagnosis engine operative to estimate failure probabilities for plans and provide diagnostic guidance to the planner.

In accordance with another aspect of the present application, a system is provided for generating target paths in response to requests from one or more users. Each of the requests is associated with one of the one or more users and a directed acyclic graph extending between a start vertex and a goal vertex, where the graph includes a plurality of prefixes defining a search space, and the prefixes individually include at least one range, a path value and a target value to go. The system includes an interface operative to communicate with the one or more users, where the interface receives the requests from the user(s). The system further includes a module operative to generate at least one target path for each of the requests. The module generates the at least one target path for the each of the requests using a target value search of the directed acyclic graph associated with the each of the requests. The target value search includes beginning with the start vertex as a current prefix and progressing through selected prefixes. The target value search further includes determining a selected prefix from successor prefixes of the current prefix according to a selection rule. The selection rule is one of selecting the successor prefix having a highest path value and selecting the successor prefix having a lowest path value. The target value search further includes setting the current prefix to the selected prefix until a frontier of a blind spot is encountered. The frontier of the blind spot is defined by an evaluation function. The target value search further includes completing at least one of the plurality of prefixes to determine the at least one target path. The system further includes a controller operative to selectively relay the requests between the interface and the module.

### BRIEF DESCRIPTION OF THE DRAWINGS

FIG. 1 is an illustration of a directed acyclic graph;

FIG. 2 is an illustration of a connection graph, and a pattern database, for a subset of vertices from the directed acyclic graph of FIG. 1;

FIG. 3 is a flow diagram illustrating an exemplary method of performing a max-value-first target value search;

FIG. 4 is an illustration of a search space of a target value path problem;

FIG. 5 is an illustration of the progression of a max-value-first target value search;

FIG. 6 is a flow diagram illustrating an exemplary algorithm for performing a max-value-first target value search;

FIG. 7 is a flow diagram illustrating another exemplary algorithm or performing a max-value-first target value search;

FIG. 8 is a simplified system diagram illustrating a max-value-first target value search (MFTVS) engine employing an exemplary method of the present application;

FIG. 9 is an exemplary system employing an exemplary method for performing a max-value-first target value search;

FIG. 10 is a schematic diagram illustrating a production system, an operative interface, and a model-based control system with a planner, a plant model, a diagnosis engine, and a MFTVS engine; and

FIG. 11 is a simplified side elevation view illustrating an exemplary modular redundant printing engine in which a model-based control system finds particular application.

### DETAILED DESCRIPTION

In a target value path problem, one is interested in finding a path between two vertices in a graph, whose sum of edge weights, or values, is as close as possible to some target value. Such problems arise in a variety of domains, such as online diagnosis for production planning systems and systems for providing consumers with targeted search results.

To define a target value path problem, a finite directed acyclic graph (DAG) is defined as G=(V_{G}, E_{G}) with a set of vertices V_{G} and a set of positive valued edges E_{G}, and p= [symbol] v₀, . . . , vₙ [symbol] is a path where vᵢ ε V_{G} and neighboring vertices are connected by edges (vᵢ, vᵢ₊₁) ε E_{G}. Further, a path value g(p) is the sum of the edge values in p. If pᵥ_{₀}_{→v}_{_{g}} is a path from vertex v₀ to v_{g} and Pᵥ_{₀}_{→v}_{g} is the set of all paths from v₀ to v_{g}, a target value path pᵥ_{₀}_{→v}_{g}^{T} with respect to v₀, v_{g} and T is the path from v₀ to v_{g} with minimal deviation between its path value and the specified target value T:

$${p}_{{v}_{0} \to {v}_{g}}^{T} ε {argmin}_{p ε {P}_{{v}_{0} \to {v}_{g}}} \vert g ( p ) - T \vert .$$

The foregoing definition of a target value path problem merely requires a directed acyclic graph G. However, for the sake of simplicity, the following discussion is limited to connection graphs. A connection graph Cᵥ_{₀}_{→v}_{_{g}}^{G} of two vertices v₀, v_{g} ε G is the sub-graph of G, including v₀, v_{g} and all vertices that are both successors of v₀ and predecessors of v_{g}, as well as all corresponding edges (ε E_{G}) between them. A connection graph Cᵥ_{₀}_{→v}_{g}^{G} can be extracted from G in linear time and space (0(|V_{G}|+|E_{G}|)) by constructing the successor graph of v₀ and the predecessor graph of v_{g} using a breadth-first sweep and taking their intersection. One suitable technique for constructing a connection graph is set forth in U.S. patent application Ser. No. 12/409,235 for “Methods and Systems for Target Value Path Identification,” by Kuhn et al., filed Mar. 23, 2009, incorporated herein by reference.

Target value search is challenging because it does not exhibit optimal substructure. A problem is said to have optimal substructure if an optimal solution can be constructed efficiently from optimal solutions of its sub-problems. This property is employed to determine the usefulness of dynamic programming and greedy algorithms, which is key to solving those problems efficiently. A shortest path problem, for example, has optimal substructure, wherein any sub-path of a shortest path is by itself a shortest path with respect to its first and last vertices. However, with respect to a target value search, a sub-path of a target value path with respect to some target value T isn't necessarily a target value path between its first and last vertices with respect to the same T.

One approach to determining the target path is to search every path between v₀ and v_{g} for the path most closely approximating some target value T. This can be performed by decomposing the argmin over complete paths from v₀ to v_{g} into a recursive set of argmin calculations over sub-paths from v′ to v_{g}, wherein v′ is an immediate successor to v₀. After traveling from v₀ to v′, some value has been added to the prefix, whereby the target value can be adjusted by this amount to get the remaining target value for the suffix of the path (i.e., referred to herein as the target value to go T′). A prefix is a path extending from v₀ to some vertex v in C, and a suffix is a path extending from some vertex v to v_{g} in C. The target value path can be defined as follows.

$${p}_{{v}_{0} \to {v}_{g}}^{T} = \{ \begin{matrix}\{ 〈 {v}_{g} 〉 \} & if {v}_{0} = {v}_{g} \\ φ & if isLeaf ( {v}_{0} ) \\ {v}_{0} \cdot φ ( T , {v}_{0} ) & otherwise\end{matrix} \\ φ ( T , {v}_{0} ) = {argmin}_{{p}^{′} ε {⋃}_{( {v}_{0} , {v}^{′} ) ε E} {p}_{{v}^{′} \to {v}_{g}}^{{T}^{′}}} \vert g ( {p}^{′} ) - {T}^{′} \vert$$

However, because the number of paths from v₀ to v_{g} in C can be exponential in the number of vertices in C, the computation can lead to an exponential blow-up.

Another approach to solving a target-value path problem is to search the prefix space using an admissible (non-overestimate) evaluation function f (pre) for the target-value deviation. Under such an approach, lower bounds and upper bounds are used to limit the search space with A*. For each vertex v in C, h⁻(v) is an non-overestimate lower bound heuristic and h⁺(v) is a non-underestimate upper bound heuristic on the path value from v to the goal vertex. Given a vertex v with its corresponding lower and upper bound heuristics, a range r(v) can be defined that bounds the path value of all possible suffixes from v to the goal vertex. The lower bound of the range is denoted as r(v).l and the upper bound is denoted as r(v).u, where:

r(v)=[h⁻(v),h⁺(v)].

Ranges for each vertex of a connection graph C extending from v₀ to v_{g} may be set forth in a pattern database pd, which can be generated using a dynamic programming sweep, wherein each vertex in the connection graph C of v₀ and v_{g} is annotated with a set of ranges encompassing the values of the paths from this vertex to v_{g}. The ranges of a vertex v represent progressive approximations of the lengths of paths from the vertex v to v_{g} (i.e., all path lengths are guaranteed to be within the ranges).

One approach to generating a pattern database pd begins by initializing pd(v_{g})=[0,0] and setting up a queue comprised of just v_{g}. In each step, a vertex is removed from the queue. Then for each in-edge e, the range is shifted by value(e) and propagated over e to the respective predecessor. Upon receiving the range, the predecessor combines its range with the received range. If the predecessor's range changes, it is added to the queue. The process is repeated until a steady state is reached (i.e., when the queue is empty).

Another approach to generating a pattern database pd begins by initializing pd(v_{g})=[0,0] and setting up a queue comprising of just v_{g}. Additionally, initialization encompasses setting successor counters for each vertex. Successor counters correspond to the number of successors a vertex has. In each step, a vertex is removed from the queue. Then for each out-edge e, the range of the corresponding successor is shifted by value(e) and propagated over e to the vertex. Upon receiving the shifted range from each successor, the vertex combines the shifted ranges. Further, the successor counters of each predecessor of the vertex are decremented. If a successor counter of a predecessor is zero, the predecessor is added to the queue. The process is repeated until a steady state is reached (i.e., when the queue is empty).

Further details pertaining to the foregoing approaches to generating a pattern database are set forth in U.S. patent application Ser. No. 12/497,326 for “Depth-First Search for Target Value Problems” and U.S. patent application Ser. No. 12/409,235 for “Methods and Systems for Target Value Path Identification,” the disclosures of which are incorporated herein by reference. However, other pattern database generation approaches are equally amenable to the exemplary method of the present invention. A pattern database fundamentally maintains one or more ranges of suffix lengths from each vertex in a connection graph to a goal vertex.

Assuming a pattern database pd, the path family of some prefix pre, denoted fam^{pre} is the set of all paths from v₀ to v_{g} sharing the common prefix pre. Given some path family fam^{pre}, a path value interval is defined as:

i(pre)=[g(pre)+r(pre.lastV).l,g(pre)+r(pre.lastV).u],

where the path value interval i(pre) bounds the path value for all paths in fam^{pre}. The lower bound of the interval is denoted as i(pre).l and the upper bound as i(pre).u. Using the interval i(pre), an admissible (non-overestimate) evaluation function f(pre) for the target-value deviation is as follows.

$$f ( pre ) = \{ \begin{matrix}0 & i ( pre ) . l \leq i ( pre ) . u \\ i ( pre ) . l - T & i ( pre ) . l > T \\ T - i ( pre ) . u & i ( pre ) . u < T\end{matrix}$$

If the target value falls in the path value interval of some prefix pre, there is potentially a path in fam^{pre} that exactly achieves the target value. In this case f(pre) returns zero, as it must be a true non-overestimate of the target-value deviation. For prefixes where the target value does not fall within the interval, since it is assumed the lower bound i(pre).l and upper bound i(pre).u are true bounds, there exists no path in fam^{pre} outside those bounds. If the target value is below the lower bound of the interval, the smallest possible deviation will be i(pre).l−T. If the target value is above the upper bound, the smallest deviation will be T−i(pre).u. The evaluation function f(pre) is therefore an admissible lower bound on the target value deviation.

The path value intervals can also be used to calculate a non-underestimate upper bound of target value deviation.

pruneBound(pre)=max (|T−i(pre).l|,|T−i(pre).u|)

This upper bound function can be used to maintain a global best upper bound on target value deviation pruneBound(best). This global best upper bound can be used to prune prefixes pre where f(pre)>pruneBound(best).

In view of the foregoing, the evaluation function f(pre), together with pruneBound(pre), can be used to search using A*. The search basically results in a shortest path search when T is below the interval and longest path search when T is above the interval. The challenge occurs when the target value falls within the interval. This case occurs often near the beginning of the search, when there are many possible path completions for each prefix, making the interval associated with the last vertex of the prefix very wide. Many vertices will therefore be assigned the same heuristic (evaluation function) value, namely zero. While admissible, this effectively forces a blind search. The blind search is not explicit, but results from the behavior of the A* algorithm. The prefixes that evaluate to zero will move to the front of A*'s priority queue and will be expanded first. A prefix that evaluates to zero (f(pre)=0) is referred to as a zero-prefix and the space of all zero-prefixes is referred to as the blind-spot.

Search in the blind-spot has two main problems: (1) search is not guided in the blind-spot and therefore will perform as poorly as the exhaustive approach discussed above; and (2) the priority queue might grow exponentially during the blind search, due to a combination of the tree structure of the exhaustive approach and the inability to prune any zero-prefixes. Target value search can therefore still lead to an exponential blow-up in time and space, since the number of prefixes in the blind-spot can be exponential in |V|. However, once the blind-spot is exhaustively searched, the target value starts to fall outside the path value intervals. Informative (non-zero) heuristic bounds will then be assigned, and informed search will again dominate.

One approach to reducing the size of the blind-spot and reducing the growth of the priority queue is to use multiple intervals. Namely, because the size of the blind-spot is directly correlated to the space covered by path value intervals, the less space covered, the smaller the blind spot is. Multi-interval heuristic target value search thus characterizes the path value space associated with a path family with a set of intervals instead of just one, where the set of intervals associated with a path family is denoted as I(pre).

A non-overestimate lower bound evaluation function on the target value deviation f(pre) in much the same fashion as for a single interval. For the multiple interval case, the target value is compared to the closest upper and lower interval bounds among all intervals of a prefix family. This can be efficiently done if the set of intervals associated with a path family is stored in a sorted and indexed data-structure.

$$f ( pre ) = \{ \begin{matrix}0 & ∃ i ∈ I : i . l \leq T \leq i . u \\ min ( {min}_{i ε I} \vert i . l - T \vert , {min}_{i ε I} \vert T - i . u \vert ) & otherwise\end{matrix}$$

The multiple intervals can also be exploited for pruning. A non-underestimate upper bound heuristic on the deviation from the set of intervals associated with some path family can be defined in a similar manner.

$$pruneBound ( pre ) = max ( {min}_{i ε I \text{:} i . l \leq T} T - i . l , {min}_{i ε I \text{:} i . u \geq T} i . u - T )$$

Further information regarding the multiple interval approach is set forth in U.S. patent application Ser. No. 12/497,353 for “Multi-Interval Heuristics for Accelerating Target-Value Search,” by Schmidt et al., filed Jul. 2, 2009, incorporated herein by reference.

Another approach to reduce the growth of the priority queue is to do away with the priority queue and utilize a depth-first target value search to search the blind spot. In contrast with the A* approach, which is traditionally more analogous to a breadth first search, the memory requirement of the depth first search approach is bounded by the target-value. If one assumes positive edge values and lets e>0 be the least edge-value in C, then at worst the target value path for some T will consist of

$$⌈ \frac{T}{e} ⌉ + 1$$

vertices. Consequently, the algorithm's space requirement is O(T). The depth first approach is equally amenable to multiple intervals. Further information concerning the depth-first target value search approach is found in U.S. patent application Ser. No. 12/497,326 for “Depth-First Search for Target Value Problems,” by Schmidt et al., filed Jul. 2, 2009, incorporated herein by reference.

The present disclosure provides another approach to reduce the growth of the priority queue by using a max-value-first search within the blind spot, instead of breadth-first search. While referred to as ‘max-value first’, the search technique can be implemented through selection of ‘max’ prefix path values or alternatively by selection of ‘min’ values, as set forth herein. In the first case, max-value-first search expands the prefix with the greatest path value g(pre) first. That is different from depth-first search, where among the prefixes with the maximum edge number (depth) any one of them may be expanded first. Max-value-first search guides the search directly to the frontier of the blind-spot where a zero-prefix will be expanded with successors which are not zero-prefixes. In the alternative, the search expands the prefix with the smallest path value g(pre) first, and likewise guides the search directly to the frontier of the blind-spot where a zero-prefix will be expanded with successors which are not zero-prefixes. In either implementation, pruning can then be applied to those successors. Both these alternative implementations are termed ‘max-value-first’ searches for ease of discussion, and both are implemented in certain embodiments be selecting a prefix from successor prefixes of a currently evaluated prefix according to a selection rule that is one of selecting the successor prefix having a highest path value and selecting the successor prefix having a lowest path value. Moreover, the max-value-first approaches may be used in connection with single-interval as well as multiple-interval searching techniques.

The max-value-first search techniques of the present disclosure, moreover, provide certain advantages from an anytime algorithm perspective. Using max-value-first search enables strong anytime performance, because the max-value-first search, in average, is the fastest out of the blind-spot (faster than depth-first search). Given a fixed number of expansion, the number of non-zero prefixes found is greater or equal then with depth-first search or breath-first search. Therefore if an anytime algorithm is desired, the most promising non-zero-prefix from A*'s priority queue can be selected and expanded towards the goal.

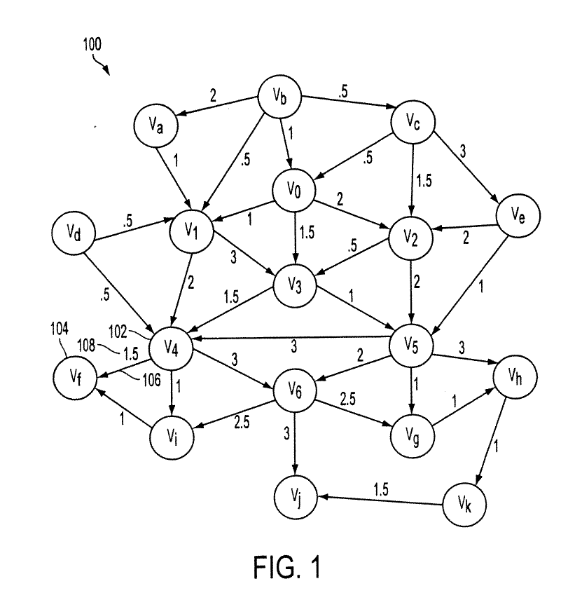

With reference to FIGS. 1-11, methods and systems discussing the max-value-first target value search are described. Like reference numerals are used to refer to like elements throughout. Further, the various features, structures, and graphical renderings are not necessarily drawn to scale.

With reference to FIG. 1, a directed acyclic graph 100 is illustrated. The graph is comprised of a plurality of vertices, such as vertices 102 and 104, interconnected by a plurality of edges, such as edge 106. The graph is acyclic such that no vertex within the graph is both an ancestor and descendant of another vertex. The vertices may be representative of, but are not limited to, system states, physical destinations, or steps in a process. Similarly, the edges may be representative of, but are not limited to, actions, or temporal, spatial or physical connections, between vertices. The plurality of edges are directed and include edge weights (or values). In the case of edge 106, for example, the edge weight 108 is 1.5. Edge weights may be representative of, but are not limited to, distances, probabilities, times, or speeds.

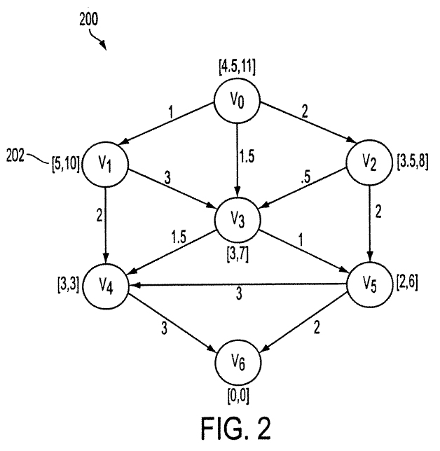

With reference to FIG. 2, a connection graph 200 of start vertex v₀ and goal vertex v₆, from the graph 100 of FIG. 1, is illustrated. A connection graph of an initial vertex and a goal vertex is a subset of a graph and includes only the initial vertex, goal vertex, and the vertices that are both descendants of the initial vertex and ancestors of the goal vertex. The connection graph 200 of FIG. 2 further illustrates a pattern database. Each vertex includes a range shown in the form of [lower bound, upper bound], such as range 202. The example of FIG. 2 discloses a single range pattern database, but FIG. 2 is equally amenable to multiple ranges, so as to facilitate a multiple interval heuristic based target value search.

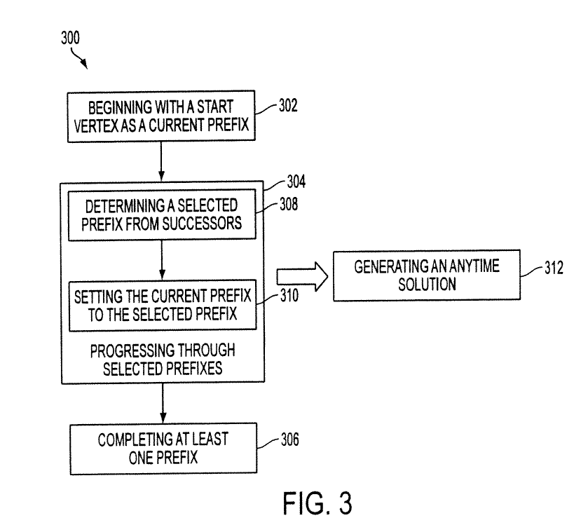

With reference to FIG. 3, an exemplary method 300 is disclosed in accordance with one or more aspects of the present disclosure. The method 300 includes the processes of beginning with a start vertex as a current prefix at 302, progressing through selected prefixes at 304 and completing at least one prefix at 306. The progression through selected prefixes at 304 in one embodiment includes determining a selected prefix from successors at 308 and setting the current prefix to the selected prefix at 310. Optionally, while progressing through the selected prefixes at 304, an anytime solution may be generated at 312.

The exemplary method 300 employs a connection graph and pattern database, such as those exemplified in FIG. 2. The connection graph includes a start vertex, a goal vertex, and a plurality of intermediary vertices. Each of the intermediary vertices is a predecessor of the goal vertex and a successor of the start vertex. The pattern database includes suffix ranges for the completion of each prefix, where exemplary techniques for the construction of a pattern database and/or the construction of a connection graph are detailed above.

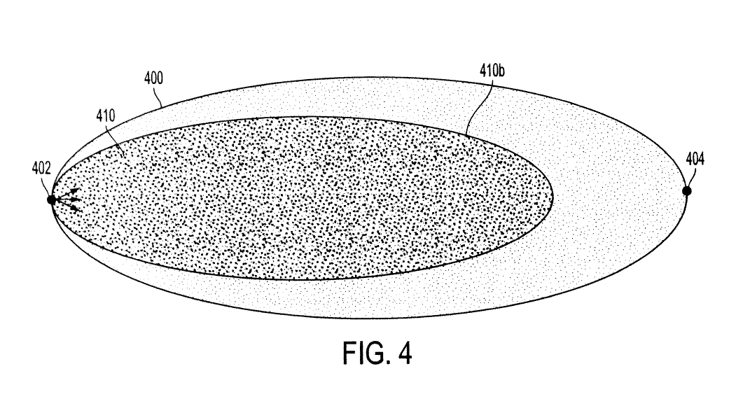

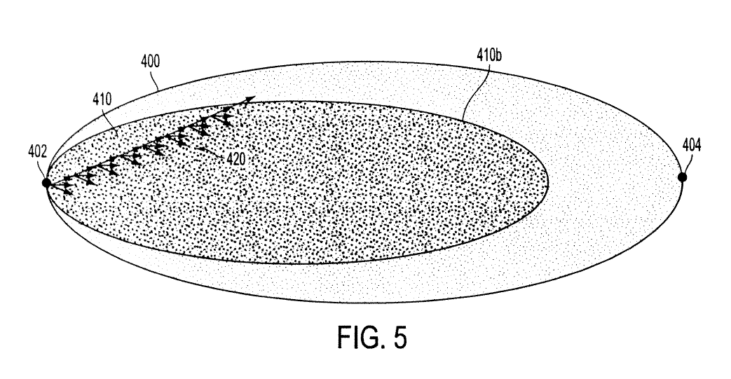

Referring now to FIGS. 3-5, the exemplary method 300 begins at the start vertex of the connection graph (e.g., 302 in FIG. 3). In one embodiment this involves initializing a current prefix to the start vertex. From there, the exemplary method 300 progresses through the search space of the connection graph at 304 in search of the optimal target path between the start vertex and the goal vertex. The search space corresponds to all of the paths extending between the start vertex and the goal vertex. Because target value search lacks optimal sub-structure, every path extending between a start vertex and a goal will generally need to be searched. FIGS. 4-5 illustrate an exemplary search space 400, including an exemplary start vertex 402, a goal vertex 404, and a blind spot 410 with a boundary or frontier 410b. However, the admissible (non-overestimate) evaluation function f(pre) described above can be used to prune the search space, such that only the blind spot 410 needs to be searched. This follows because outside the blind spot 410, the optimal completion of a prefix is known.

As best shown in FIG. 5, an exemplary max-value-first search 420 progresses through the blind spot 410 (304 in FIG. 3) in a generally depth-first fashion, except that the prefixes leading to the depth of the connection graph are selected according to a selection rule. The selection rule in the max-value-first search 420 is one of selecting the prefix with the longest path value and selecting the prefix with the shortest path value. Accordingly, the successor prefix of the current prefix with the longest path value, or the shortest path value, is selected (308 in FIG. 3) and the current prefix is set to the selected prefix (310 in FIG. 3). Because the progression begins at the start vertex 402, the successor prefixes of the prefix comprised of the start vertex 402 are looked at first. Thereafter, this is repeated until the frontier (boundary) 410b of the blind spot 410 is reached.

The frontier 410b of the blind spot 410 is determined in one of at least two ways depending upon the particular approach used. Under a depth-first approach, the frontier 410b is determined by looking at whether the evaluation function (heuristic) value for the current prefix indicates the optimal completion of the current prefix. Under an A* approach, the frontier 410b of the blind spot 410 is determined by looking to whether the evaluation function value for the selected prefix indicates the optimal completion of the selected prefix. The evaluation function indicates the optimal completion of a prefix when it returns the deviation of the path value of the optimal completion of the prefix from the target value. In one embodiment, the evaluation function indicates the optimal completion of a prefix when the evaluation function value of the prefix is non-zero. As should be appreciated, while searching the blind spot 410, under the depth-first approach the current prefix will extend outside the blind spot 410, whereas under the A* approach the current prefix will not extend outside the blind spot 410. FIG. 5 exemplifies the progression 420 to the frontier (border, or boundary) 420b of the blind spot 410.

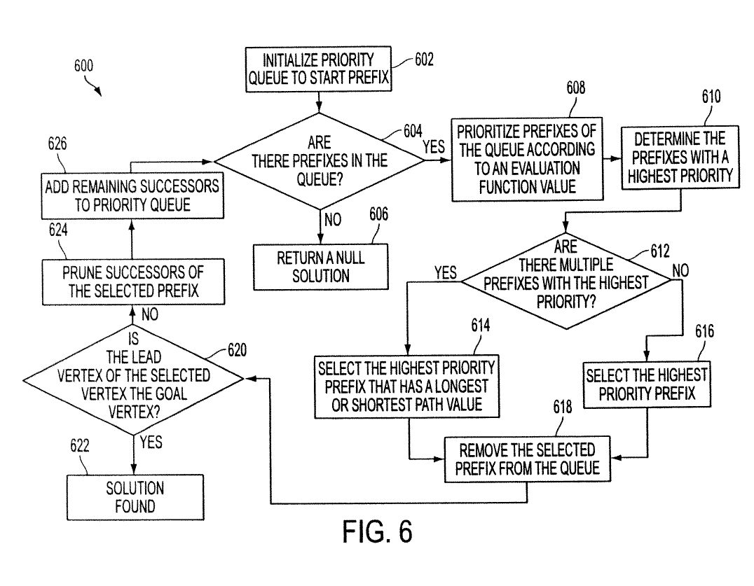

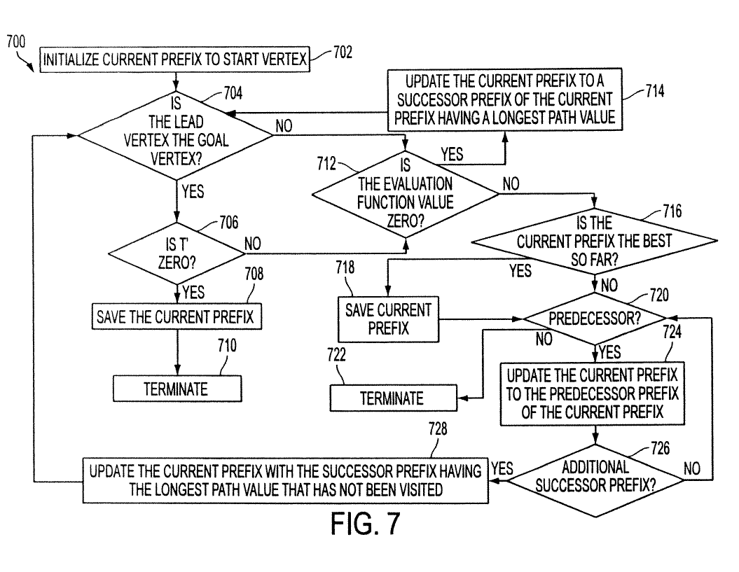

Once the frontier 410b has been encountered, one of two processes takes place depending upon the approach used. Under the depth-first approach, once the frontier 410b of the blind spot 410 is reached, no further searching along the current prefix is necessary. Namely, the optimal completion of the current prefix is known, whereby it would be computationally inefficient to search beyond the current prefix. Accordingly, under the depth-first approach, after the frontier 410b is reached, the predecessor prefix of the current prefix is selected and the current prefix is set to the selected prefix. Thereafter, if there are additional successor prefixes of the current prefix that have not been explored, the progression 420 proceeds as discussed in the preceding paragraph until the frontier 410b is reached again. Otherwise, the predecessor of the current prefix is selected again and the current prefix is set to the selected prefix. This proceeds until the current prefix is the start prefix and all of its successors have been expanded. Under the A* approach, any other successor prefixes of the current prefix are explored. If there are no additional successor prefixes of the current prefix, the predecessor prefix of the current prefix is selected according to the depth-first approach. This process will be further detailed with reference to FIGS. 6 and 7 below.

Because longest and shortest path problems exhibit optimal substructure, proceeding according to the foregoing approaches ultimately results in the prioritized search of all the prefixes extending from the start vertex 402 to the frontier 410b of the blind spot 410, wherein the prioritized search may be on the basis of longest path value or shortest path value.

While searching the blind spot 410, the exemplary method 300 tracks the best prefix encountered so. That is to say, once a prefix whose optimal completion is known is found, a determination is made as to whether the optimal completion of the prefix leads to the best solution encountered so far. If the prefix is the best solution so far, it is saved. This is advantageous in that it allows the construction of an anytime solution. An anytime solution is a quick solution that is not necessarily optimal, but is the best solution encountered so far. As should be appreciated, the max-value-first search of the present disclosure facilitates the generation of an anytime solution by proceeding to the frontier 410b, on average, as fast as possible. Accordingly, while the overall search of the blind spot 410 may take a long time, an anytime solution may be provided quickly before the search of the blind spot 410 has completed at 312. In the case of FIG. 5, the anytime solution would be the target path extending from the prefix leading outside the frontier 410b.

After the progressing through the blind spot at 304 in FIG. 3, at least one prefix is completed at 306, thereby yielding at least one target path. The completion of one or more prefixes at 306 depends upon the approach used to perform the max-value-first target value search. Under the A* approach, nothing need be done because the A* approach will complete the prefix by virtue of the use of the admissible (non-overestimate) evaluation function. However, under the depth-first approach, either an explicit solution or an implicit solution will be returned. An explicit solution is a complete solution in that it is a target path extending from the start vertex 402 to the goal vertex 404. An implicit solution is a target path extending from the start vertex 402 to some vertex in the connection graph, where the some vertex is not the goal vertex 404. This implicit solution corresponds to the best prefix encountered once the search of the blind spot 410 has completed. To complete the implicit solution, the longest path or shortest path leading from the best prefix to the goal vertex 404 is found. As should be appreciated, there are numerous shortest path and/or algorithms that lend themselves to solving this problem. Further, due to the optimal substructure of shortest and longest path problems, the time complexity of completing the solution is minimal.

With reference to FIG. 6, a process 600 of an A* approach for performing the method 300 discussed above is illustrated. For discussion of this exemplary the A* approach, a pattern database and a corresponding connection graph are presupposed. The pattern database may be generated in any number of ways, such as those described above, to provide ranges of suffix lengths for the completion of the prefixes of the connection graph. Further, the connection graph includes a start vertex, a goal vertex, and one or more vertices which are successors of the start vertex and predecessors of the goal vertex, and may be generated in any number of ways. Moreover, although a connection graph is discussed, it should be appreciated that the exemplary methods are equally amenable to other directed acyclic graphs. Further details pertaining to the A* approach are described in U.S. patent application Ser. No. 12/409,235 for “Methods and Systems for Target Value Path Identification,” incorporated herein by reference.

The A* approach 600 begins in FIG. 6 by initializing a priority queue with a prefix comprised of the start vertex (402 in FIGS. 4 and 5 above) of the connection graph at 602. After the priority queue is initialized at 602, a determination is made as to whether there are prefixes in the queue at 604. This determination at 604 is the termination condition of an iterative review of prefixes in the queue. If there are no prefixes in the queue (NO at 604), there is a general failure in the algorithm, whereby a null solution is returned at 606. The general failure could, for example, mean an improper connection graph was used. If there are prefixes in the queue (YES at 604), the prefixes are prioritized at 608 according to the admissible (non-overestimate) evaluation function f(pre), discussed above. As previously noted, the evaluation function returns the minimum deviation of the target value from the path value of the best completion of a prefix. A minimum deviation of zero indicates there could be a perfect solution (i.e., a solution with a path value equal to the target value 7). After prioritizing the prefixes (Process 608), the prefixes with the highest priority are determined at 610. The prefixes with the highest priority are those prefixes with the smallest evaluation function values. In one embodiment, all those prefixes with an evaluation function value of zero are the prefixes with the highest priority.

Once the prefixes with the highest priority have been determined at 610, a determination as to whether there are multiple highest priority prefixes is made at 612. This will be prevalent when searching within the blind spot 410 illustrated in FIGS. 4-5. If there is more than one highest priority prefix (e.g., more than one prefix with an evaluation function value of zero, YES at 612), the prefix with the longest path value is selected from the highest priority prefixes at 614. Alternatively, instead of selecting the prefix with the longest path value, the prefix with the shortest path value can be selected. Regardless of whether the longest path value or the shortest path value is used, the use of the longest path value or the shortest path value should be consistent throughout the duration of the search. If there is only one highest priority prefix (NO at 612), that prefix is selected at 616. Thereafter, the selected prefix is removed from the priority queue at 618.

After the selected prefix is removed from the priority queue at 618, a determination is made as to whether the lead vertex of the selected prefix is the goal vertex at 620. The lead vertex of a prefix is the deepest vertex of the prefix (i.e., the vertex of the prefix closest to the goal vertex 404). If the lead vertex of the selected prefix is the goal vertex 404 (YES at 620), an optimal target path between the start vertex 402 and the goal vertex 404 has been found, and the optimal target path is returned and the search terminates at 622. If the A* approach is provided a proper connection graph and pattern database, this condition will always be met, so that the process never goes to 606 in FIG. 6. If the lead vertex of the selected prefix is not the goal vertex 404 (NO at 620), the successor prefixes of the selected prefix are pruned using the evaluation function at 624. Pruning only takes place outside of the blind spot 410 shown in FIGS. 4-5 because outside of the blind spot 410, the optimal completion of prefixes is known. After the successor prefixes of the selected prefix are pruned, the remaining successor prefixes are added to the priority queue at 626. At this point, the foregoing process discussed above repeats, and does so until the entire search space has been searched, i.e., until the lead vertex of the selected vertex is the goal vertex 404.

With reference to FIG. 7, an exemplary depth-first process 700 is illustrated for performing the method 300 of FIG. 3 discussed above. For the following discussion pertaining to the depth-first approach, a pattern database and a corresponding connection graph are again presupposed. The pattern database including ranges of suffix lengths for the completion of the prefixes of the connection graph may be generated in any number of ways, and the connection graph may be generated in any number of ways having a start vertex 402, a goal vertex 404, and one or more vertices which are successors of the start vertex 402 and predecessors of the goal vertex 404. Although a connection graph is presupposed, the exemplary depth-first process 700 is equally amenable to other directed acyclic graphs. More information pertaining to this approach is described in U.S. patent application Ser. No. 12/497,326 for “Depth-First Search for Target Value Problems,” incorporated herein by reference.

The depth-first approach begins at 702 in FIG. 7 by initializing a current prefix to the start vertex of the connection graph, after which a determination is made as to whether the lead vertex of the current prefix is the goal vertex 404 at 704. This is part of the termination condition. If the lead vertex of the current prefix is the goal vertex 404 (YES at 704), a determination is made at 706 as to whether the target value to go (T′) of the current prefix is zero. When the target value to go is zero (YES at 706), a perfect solution exists (i.e., a target path between the start vertex 402 and the goal vertex 404 with a path value equal to the target value). Accordingly, the search process 700 need not continue, the current prefix is saved at 708 and the search terminates at 710.

If the lead vertex is not the goal vertex 404 or the target value to go is not zero (NO at 704 or 706), the process 700 continues at 712 with the evaluation function value of the current prefix being examined. As discussed above, the evaluation function value is the minimum deviation of the path value of the optimal completion of the current prefix from the target value. In one embodiment, the evaluation function value of the current prefix is zero, whereby the current prefix is within the blind spot 410 of FIGS. 4-5. If the evaluation function value is zero (i.e., the current prefix is in the blind spot 410, YES at 712), the current prefix is changed to its successor prefix at 714 with the longest path value (or, alternatively, the shortest path value depending on the selection rule used in a given implementation), and the process 700 returns to 704. If the evaluation function value is not zero (NO at 712), the search need not continue any further along the current prefix since the best completion of the current prefix is known. Accordingly, a determination is made at 716 as to whether the current prefix is the best prefix encountered so far. The best prefix encountered is the prefix encountered so far with the least deviation from the target value of any other prefix encountered so far. If the current prefix is the best prefix encountered so far (YES at 716), the current prefix is saved at 718. By this process, as the depth-first search proceeds, the saved prefix is updated.

Thereafter, a determination is made as to whether the current prefix has a predecessor prefix at 720. The predecessor prefix is the prefix from which the current prefix was derived (i.e., the current prefix is a successor prefix of the predecessor prefix). This takes place regardless of whether the current prefix is the best so far. It is noted that the only time when the current prefix will not have a predecessor prefix is when the current prefix is comprised solely of the start vertex 402. If the current prefix does not have a predecessor prefix (NO at 720), the depth first search terminates at 722, whereby the search has completed. Upon termination, if everything went properly, there should be a saved prefix which implicitly leads to the optimal target path. Namely, using either a shortest path or longest path algorithm, the saved prefix can be expanded in linear time to achieve the target path. If the current prefix has a predecessor prefix (YES at 720), the current prefix is updated to the predecessor prefix at 724.

Assuming the current prefix has a predecessor prefix, the updated current prefix is checked for additional successor prefixes at 726. Additional successor prefixes refer to successor prefixes of the current prefix that have not been expanded. If there are additional successor prefixes (YES at 726), the current prefix is updated with the successor prefix having the longest path value at 728. Alternatively, the current prefix can be updated with the successor prefix having the shortest path value. Thereafter, the process repeats again at 704. If there are no additional successor prefixes (NO at 726), the depth-first search approach 700 tries to proceed to the predecessor of the current prefix as previously discussed at 720.

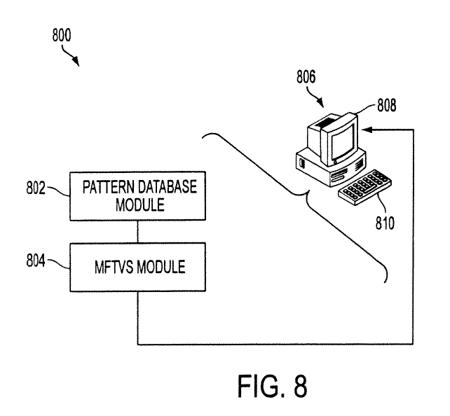

With reference to FIG. 8, a max-value-first target value search (MFTVS) engine 800 is shown. The exemplary MFTVS engine 800 is suitably embodied by a computer 806, or other digital processing device including a digital processor, such as a microprocessor, microcontroller, graphic processing unit (GPU), etc. and storage. In other embodiments, the MFTVS engine 800 may be embodied by a server including a digital processor and including or having access to digital data storage, such server being suitably accessed via the Internet or a local area network, or by a personal data assistant (PDA) including a digital processor and digital data storage, or so forth. The computer 806 or other digital processing device suitably includes or is operatively connected with one or more user input devices such as an illustrated keyboard 810 for receiving user input to control the MFTVS engine 800, and further includes or is operatively connected with one or more display devices such as an illustrated display 808 for displaying output generated based on the output of the MFTVS engine 800. In other embodiments, the input for controlling the MFTVS engine 800 is received from another program running previously to or concurrently with the MFTVS engine 800 on the computer 806, or from a network connection, or so forth. Similarly, in other embodiments the output may serve as input to another program running subsequent to or concurrently with the MFTVS engine 800 on the computer, or may be transmitted via a network connection, or so forth.

The MFTVS engine 800 includes a pattern database module 802 and a MEWS module 804. The pattern database module 802 receives a connection graph from a source external to the MFTVS engine 800, and generates a pattern database for the connection graph. The pattern database is preferable carried out according to one of the approaches for generating a pattern database discussed above. The MFTVS module 804 receives the pattern database and the connection graph from the pattern database module 802. The MFTVS module 804 further receives a target value from a source external to the MFTVS engine 800, such as the keyboard 810. The MFTVS module 804 uses the received target-value, pattern database and connection graph to find a target path within the connection graph which has a path length most closely approximating the target value. The MFTVS module 804 searches for the target path according to the exemplary method of FIG. 3, discussed above. The MFTVS module 804 may further provide an anytime solution in response to a request from an external source, such as the keyboard 810, while searching. If an anytime solution is provided, the anytime solution is output for display, printout and/or implementation into additional decision making mechanisms, such as planners. Notwithstanding the anytime solution, after the search is complete, the target path is output for display, printout and/or implementation into additional decision making mechanisms, such as planners.

In some embodiments, the exemplary methods, discussed above, the MFTVS engines employing the same, and so forth, of the present invention are embodied by a storage medium storing instructions executable (for example, by a digital processor) to implement the target value search. The storage medium may include, for example: a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth.

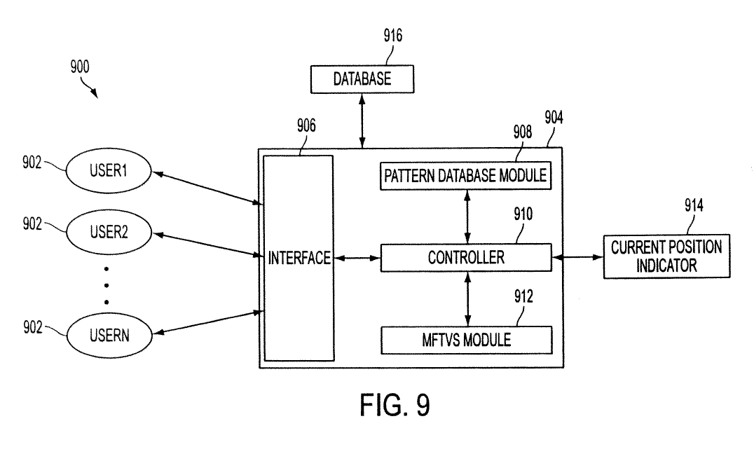

With reference to FIG. 9, an exemplary system 900 for performing a max-value-first target value search is illustrated. The system 900 finds particular application in providing directions between two points (such as a start address and an end address). The system includes one or more users 902, a target path generating system 904, a database 916, and, optionally, a current position indicator 914. The current position indicator 914 and/or the database 916 may be internal to the target path generating system 904 or external to the target path generating system 904 as shown in FIG. 9. The target path generating system 904 includes an interface 906, a pattern database module 908, a controller 910 and a MFTVS module 912. As should be appreciated, the individual components of the target path generating system 904 may be localized to a single computing system or distributed across a plurality of computing systems interconnected by a communications network, such as the Internet.

The one or more users 902 are individuals, corporations, governmental agencies, other like parties. However, preferably the one or more users 902 are average home users browsing the Internet or interfacing with a portable GPS unit. The interface 906 interfaces with the one or more users 902 and receives requests from the one or more users 902. The interface 906 serves to provide the one or more users 902 with a user friendly interface to the MFTVS module 912, which exemplifies the present invention. The interface 906 may be a web interface such as MapQuest™, a computer interface, such as that of a portable GPS unit like TomTom™, or other like interfaces. The requests may be requests for a path between two points, such as driving directions, wherein the path most closely achieves a given target value. For example, the request may be for driving directions between A and B, where the driving directions most closely approximate a driving distance of 100 miles. The database 916 may be a traditional database such as a database provided by MySQL, MSSQL, Oracle, Microsoft Access, or other like database, or it may simply be a data structure stored within the memory of one of one or more computer systems comprising the system 900. The current position indicator 914 may be a GPS unit and/or any other system for navigation. The pattern database module 908 generates a pattern database between a start vertex and an end vertex and preferably stores the pattern database in the database 916. The MFTVS module 912 is similar to the MFTVS module 804 of FIG. 8, whereby it generates a path in response to requests routed to it via the controller 910. As should be appreciated, the MFTVS module 912 generates the path according to the exemplary method discussed in connection with FIG. 3. Further, the approaches of FIGS. 6-7, or any other like approaches, may be used with the MFTVS module 912. The controller 910 acts to bridge and/or relay communications between the components of the target path generating system 904. The controller 910 receives the requests from the one or more users 902 via the interface 906. Thereafter, the controller 910 determines how to respond to the request and relays the request as appropriate.

One particular embodiment surrounding the exemplary system 900 is an e-commerce system, such as MapQuest, for providing driving directions. Under such a system, the database 916 includes a graph representing the road system in the particular region where the system 900 is to be used. The vertices of the graph correspond to intersections and the edges correspond to roads, highways, freeways, etc., whereby the edge weights correspond to the lengths of the roads, highways, freeways, etc. Further the one or more users 902 are preferably connected to the target path generating system 904 via the Internet, where the interface 906 provides the one or more users 902 with a web interface from which to interact with the rest of the target path generating system 904.

Under normal operation, the target path generating system 904 receives requests from the one or more users 902 via the interface 906. For example, the one or more users visit a web interface provided by the interface 906 and submit a request to generate driving directions. Thereafter, the controller 910 receives the requests from the interface 906 and determines how to process the requests. Preferably, each request includes a starting address and an ending address. Further, each request includes a target value, where the target value corresponds to the distance the corresponding user wants to drive. Alternatively, the target value corresponds to time or other like metrics applicable to roads, highways, freeways, etc.

Based upon a request, the controller 910 determines whether the database 916 includes a pattern database for the start address and the end address. If the database 916 includes a pattern database, the controller 910 relays the request to the MFTVS module 912, where the MFTVS module 912 generates a path between the start address and the end address most closely approximately the target value. As should be appreciated, this is accomplished using the exemplary method of the present invention, discussed in FIG. 3. If the database 916 does not include a pattern database, the controller 910 generates a request to generate a pattern database between the start address and the end address, and submits the request to the pattern database module 908. Naturally, the pattern database module 908 will generate the pattern database in response to the request. After the pattern database module 908 has completed the pattern database, it preferably stores it in the database 916 and notifies the controller 910. The controller 910 then proceeds to route the initial request to the MFTVS module 912. The MFTVS module 912 generates the path and provides the controller 910 with the path. The controller then returns the path to the interface, where the interface 906 formats the path as driving directions and displays it to the user of the particular request. As should be appreciated, the MFTVS module 912 may return an anytime solution while finding the optimal target path, whereby initial driving directions can be displayed to the user while completing the target value search.

Another particular embodiment surrounding the exemplary system 900 is a GPS system, such as TomTom, for providing driving directions. The GPS system may be, for example, a portable GPS, a car GPS, or other like GPS unit. Under such a system, the database 916 is local to the system and includes a graph representing the road system in the particular region where the system 900 is to be used. The vertices of the graph correspond to intersections and the edges correspond to roads, highways, freeways, etc., whereby the edge weights correspond to the lengths of the roads, highways, freeways, etc. Further, the one or more users 902 preferably interface with the target path generating system 904 via a touch screen display, where the interface 906 provides the one or more users 902 with an interactive user interface for interfacing with the rest of the target path generating system 904.

Under normal operation, the target path generating system 904 receives requests from the one or more users 902 via the interface 906. For example, the one or more users 902 selects a driving directions option on a touch screen display of the interface 906. Thereafter, the controller 910 receives the requests from the interface 906 and determines how to process the requests. Preferably, each request includes a starting address and an ending address. Further, each request should include a target value, where the target value corresponds to the distance the corresponding user wants to drive. Alternatively, the target value could correspond to time or other like metric applicable roads, highways, freeways, etc.

Based upon a request, the controller 910 determines whether the database 916 includes a pattern database for the start address and the end address. If the database 916 does include a pattern database, the controller 910 relays the request to the MFTVS module 912, where the MFTVS module 912 generates a path between the start address and the end address most closely approximately the target value. As should be appreciated, this is accomplished using the exemplary method of the present invention, discussed in FIG. 3. If the database 916 does not include a pattern database, the controller 910 generates a request to generate a pattern database between the start address and the end address, and submits the request to the pattern database module 908. Naturally, the pattern database module 908 will generate the pattern database in response to the request. After the pattern database module 908 has completed the pattern database, it stores it in the database 916 and notifies the controller 910. The controller 910 then proceeds to route the request to the MFTVS module 912. The MFTVS module 912 generates the path and provides the controller 910 with the path. The controller 910 then returns the path to the interface 906, where the interface 906 formats the path as driving directions and displays a map view of the driving directions to the user of the particular request. As should be appreciated, the MFTVS module 912 may return an anytime solution while finding the optimal target path, whereby initial driving directions can be displayed to the user while completing the target value search.

The interface 906 may further display the location of the GPS system on a map view of the driving directions by using the current position indicator 914. In this case, the current position indicator 914 provides the controller 910 with the location of the GPS system. Thereafter, the controller 910 provides the location to the interface 906, wherein the interface 906 updates the display to reflect the current position of the GPS system on the map view of the driving directions.

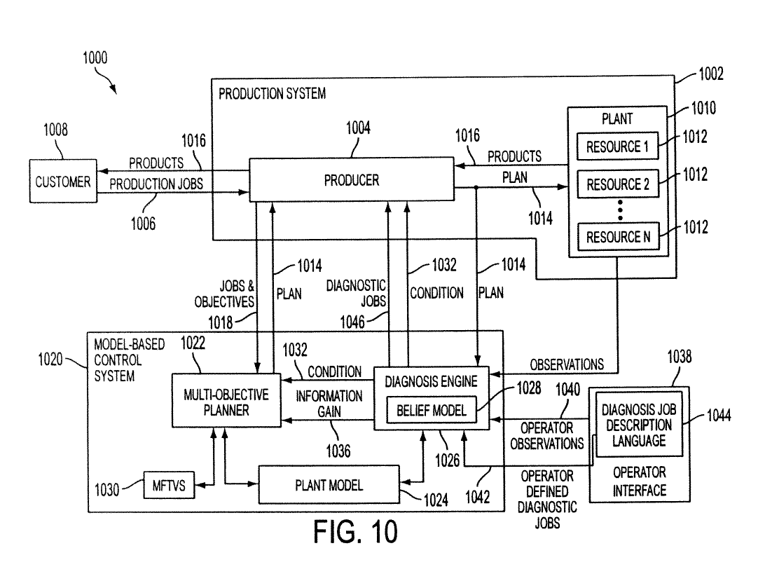

Turning to FIG. 10, the MFTVS engine 800 of FIG. 8 is employed by a system 1000. The system 1000 includes a production system 1002 having a producer component 1004 that receives production jobs 1006 from customer 1008. The resources may be, but need not be, machines, software or logic components, objects, etc. The production system further includes a plant 1010 having a plurality of resources 1012 that may be selectively actuated or operated according to one or more plans 1014, so as to produce one or more products 1016 for provision to the customer 1008. Plans 1014 are comprised of a series of actions to achieve one or more production goals. The producer 1004 provides jobs and objectives 1018 to a multi-objective planner 1022 of model-based control system 1020, and production system 1002 receives plans 1014 from planner 1022 for execution in the plant 1010. The plans 1014 can include one or both of production and diagnostic goals.

As shown in FIG. 10, control system 1020 further includes a plant model 1024 of the plant 1010, a diagnosis engine 1026 with a belief model 1028 and a MFTVS engine 1030. The diagnosis engine 1026 determines and updates a current plant condition 1032 based on one or more previously executed plans 1014, corresponding observations 1034 from the plant 1010, and the model 1024. The diagnosis engine 1026 also provides expected information gain data 1036 to the planner 1022 for one or more possible plans 1014 based on observations 1034 and the plant model 1024. The MFTVS engine 1030 implements the exemplary max-value-first target value search 300 of the present disclosure, shown in FIG. 3, and aids the multi-objective planner in constructing plans which facilitate pervasive diagnosis.

An objective of pervasive diagnosis is to use the diagnosis engine's beliefs to influence plans to gain additional information about the condition of the plant 1010. A plan is informative if it contributes information to the diagnosis engine's beliefs, and the plan outcome has a reasonable amount of uncertainty. The model-based control system 1020 facilitates pervasive diagnosis with the selective employment of intelligent on-line diagnosis through construction and execution of plans that provide enhanced diagnostic information according to the plant condition 1032 and/or the expected information gain 1036. The model-based control system 1020 may further facilitate pervasive diagnosis with the generation of one or more dedicated diagnostic plans for execution in the plant 1010 based on at least one diagnostic objective and the plant condition 1032. Thus, the model-based control system 1020 seeks to find a plan that achieves production goals and diagnostic goals.

The embodiment of FIG. 10 also includes an operator interface 1038 implemented in the form of a computer or other platform(s). Operator interface 1038 is operatively coupled with diagnosis engine 1026 to provide operator observations 1040 to the diagnosis engine 1026, with the diagnosis engine 1026 determining the current plant condition 1032 based at least partially on the operator observations 1040 in certain implementations. Moreover, the exemplary operator interface 1038 allows the operator to define a diagnostic job 1042 using a diagnosis job description language 1044, and the diagnosis engine 1026 may provide diagnostic jobs 1046 to the producer 1004. The diagnosis engine 1026 in this implementation is operative to selectively provide one or more self-generated diagnostic jobs 1046 and/or operator defined diagnostic jobs 1042 to the producer 1004, which in turn provides jobs and objectives 1018 to the planner 1022.

Referring back to the MFTVS engine 1030, the engine 1030 returns a plan operative to produce an optimal amount of diagnostic information to the planner 1022. In doing this, the MFTVS engine 1030 maps a pervasive diagnosis problem to a target value problem. Thereafter, the MFTVS engine 1030 uses the exemplary max-value-first target value search process 300 shown in FIG. 3 to solve the following equation and produce a plan with an optimal amount of uncertainty.

p^{opt}=argmin_{achievesGoal(p)εP}|Pr(ab(p))−T|

As should be apparent, p^{opt} corresponds to an optimal plan. Additionally, Pr(ab(p)) is the failure probability of plan p, and T is the optimal uncertainty. P is a set of plans that achieve the goals for the optimal plan p^{opt}. A plan with an optimal amount of uncertainty is a plan that produces an optimal amount of information.

To map a pervasive diagnosis problem to a target value problem, a graph and a connection graph, derived from the graph, are constructed. The vertices of the graph correspond to system states and the edges of the graph correspond to actions. A plan corresponds to a plurality of actions. Additionally, the edge weights correspond to the failure probability of the corresponding edge (or action), and the optimal amount of uncertainty corresponds to the target value. Further information pertaining to pervasive diagnosis is set forth in U.S. patent application Ser. No. 12/170,542 for “Methods and Systems For Pervasive Diagnostics,” incorporated herein by reference.

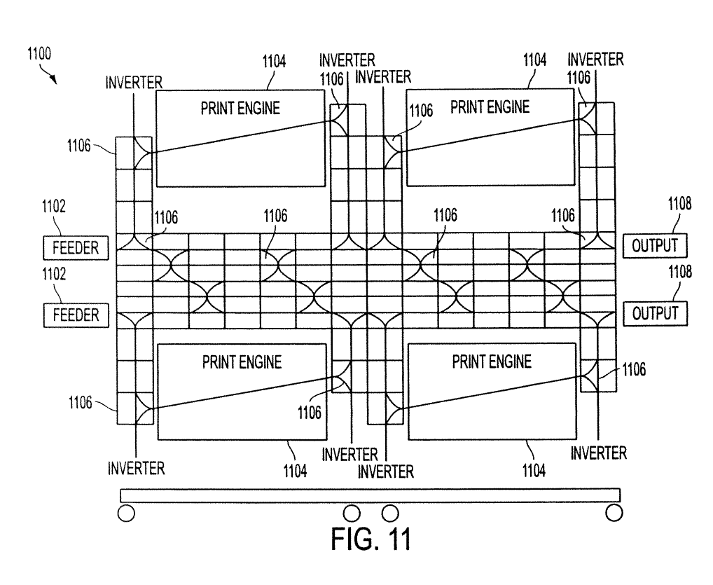

With reference to FIG. 11, a modular redundant printing system 1100 is illustrated exemplifying one practical application of the model-based control system discussed above. The system includes 197 independent modules including feeders 1102, marking (print) engines 1104, redirectors or inverters 1106, finishers, and output trays 1108, etc. The modules work together to produce a variety of printed products. Given a user specified goal, such as “a bound report with the following pages and spot colors”, a model-based control system is used to synthesize a control program to provide real time coordination and control for the modules, for example, using the above-described MFTVS techniques to determine production (print) plans employing one or more of the modules of the system 1100 according to a target value T. In addition to control, the model-based system can automatically reason about recovery from faults. In printing systems, rare intermittent faults can be particularly difficult to diagnose. To reduce the cost of diagnosis, it is possible to subtly alter production plans to exercise the machine so as to produce more information than a regular production plan.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A computer implemented method for determining at least one target path from a start vertex to a goal vertex within a directed acyclic graph, wherein the directed acyclic graph includes a plurality of prefixes defining a search space, wherein the plurality of prefixes individually include at least one range, a path value and a target value to go, the method comprising:
beginning with the start vertex as a current prefix and progressing through selected prefixes;
determining a selected prefix from successor prefixes of the current prefix according to a selection rule, the selection rule being one of selecting the successor prefix having a highest path value and selecting the successor prefix having a lowest path value;
setting the current prefix to the selected prefix until a frontier of a blind spot is encountered, wherein the frontier of the blind spot is defined by an evaluation function; and
completing at least one of the plurality of prefixes to determine the at least one target path.

2. The computer implemented method of claim 1, further comprising:
computing an evaluation function value for the selected prefix based on a target value to go for the selected prefix and at least one range for the selected prefix, wherein the frontier of the blind spot is encountered when the evaluation function value for the selected prefix indicates an optimal completion of the selected prefix.

3. The computer implemented method of claim 1, further comprising:
computing an evaluation function value for the current prefix, wherein the frontier of the blind spot is encountered when the evaluation function value for the current prefix indicates an optimal completion of the current prefix.

4. The computer implemented method of claim 1, wherein the evaluation function determines the minimum deviation of the target value to go of one of the plurality of prefixes from the at least one range of the one of the plurality prefixes.

5. The computer implemented method of claim 1, further comprising:
saving a prefix having a best completion encountered so far.

6. The computer implemented method of claim 5, further comprising:
generating an anytime target path from the prefix having the best completion encountered so far.

7. The computer implemented method of claim 5, further comprising:
completing the prefix having the best completion after the search space has been completely searched.

8. The computer implemented method of claim 1, further comprising:
selecting a predecessor prefix of the current prefix until the predecessor prefix includes successor prefixes which have not been expanded; and
setting the current prefix to the selected predecessor prefix.

9. The computer implemented method of claim 1, further comprising:
prioritizing open prefixes according to the evaluation function value.

10. A model based control system for controlling a production system, wherein the model based control system includes a directed acyclic graph extending between a start vertex and a goal vertex, wherein the directed acyclic graph includes a plurality of prefixes defining a search space, wherein the plurality of prefixes individually include at least one range, a path value and a target value to go, said model based control system comprising:
a planner operative to provide the production system with at least one plan with a failure probability most closely approximating a target value, wherein the planner generates the at least one plan using a target value search of the directed acyclic graph, said target value search comprising:
beginning with the start vertex as a current prefix and progressing through selected prefixes;
determining a selected prefix from successor prefixes of the current prefix according to a selection rule, the selection rule being one of selecting the successor prefix having a highest path value and selecting the successor prefix having a lowest path value;
setting the current prefix to the selected prefix until a frontier of a blind spot is encountered, wherein the frontier of the blind spot is defined by an evaluation function; and
completing at least one of the plurality of prefixes to determine the at least one plan;
a system model operative to model the behavior of the plant; and,
a diagnosis engine operative to estimate failure probabilities for plans and provide diagnostic guidance to the planner.

11. The model based control system of claim 10, wherein the directed acyclic graph includes a plurality of vertices interconnected by a plurality of edges, wherein each of the plurality of vertices include a production system state and each of the plurality of edges include a production system action and a corresponding failure probability.

12. The model based control system of claim 10, wherein the target value corresponds to the optimal amount of uncertainty in a plan outcome of the at least one plan.

13. The model based control system of claim 10, further comprising:
computing an evaluation function value for the selected prefix based on a target value to go for the selected prefix and at least one range for the selected prefix, wherein the frontier of the blind spot is encountered when the evaluation function value for the selected prefix indicates an optimal completion of the selected prefix.

14. The model based control system of claim 10, further comprising:
computing an evaluation function value for the current prefix, wherein the frontier of the blind spot is encountered when the evaluation function value for the current prefix indicates an optimal completion of the current prefix.

15. The model based control system of claim 10, wherein the evaluation function determines the minimum deviation of the target value to go of one of the plurality of prefixes from the at least one range of the one of the plurality prefixes.

16. A system for generating target paths in response to requests from one or more users, wherein each of the requests is associated with one of the one or more users and a directed acyclic graph extending between a start vertex and a goal vertex, wherein the directed acyclic graph includes a plurality of prefixes defining a search space, wherein the plurality of prefixes individually include at least one range, a path value and a target value to go, said system comprising:
an interface operative to communicate with the one or more users, wherein the interface receives the requests from the one or more users;
a module operative to generate at least one target path for each of the requests, wherein the module generates the at least one target path for the each of the requests using a target value search of the directed acyclic graph associated with the each of the requests, the target value search comprising:
beginning with the start vertex as a current prefix and progressing through selected prefixes;
determining a selected prefix from successor prefixes of the current prefix according to a selection rule, the selection rule being one of selecting the successor prefix having a highest path value and selecting the successor prefix having a lowest path value;
setting the current prefix to the selected prefix until a frontier of a blind spot is encountered, wherein the frontier of the blind spot is defined by an evaluation function; and
completing at least one of the plurality of prefixes to determine the at least one target path; and
a controller operative to selectively relay the requests between the interface and the module.

17. The system of claim 16, wherein the interface communicates with the one or more users via a communications network.

18. The system of claim 16, wherein the interface communicates with the one or more users via a user input device.

19. The system of claim 16, wherein the module generates an anytime solution before the target value search completes.

20. The system of claim 16, wherein the interface provides each of the one or more users with driving directions based upon the at least one path for the request associated with the each of the one or more users.
